(19) United States
(12) Patent Application Publication
(10) Pub. No.: US 2025/0091291 A1
(43) Pub. Date: Mar. 20, 2025

(54) INTEGRATED DEVICE OF BI-DIRECTIONAL ULTRASONIC ROLLING, POWDER SPREADING, AND COMPACTION FOR ADDITIVE MANUFACTURING

(71) Applicant: China University of Mining and Technology, Xuzhou (CN)

(72) Inventors: Jingbin Hao, Xuzhou (CN); Xuanyu Zheng, Xuzhou (CN); Haifeng Yang, Xuzhou (CN); Hao Liu, Xuzhou (CN); Qin Du, Xuzhou (CN); Jianhua Hu, Xuzhou (CN); Ding Shen, Xuzhou (CN); Xinhua Liu, Xuzhou (CN)

(21) Appl. No.: 18/799,945

(22) Filed: Aug. 9, 2024

(30) Foreign Application Priority Data
Sep. 14, 2023 (CN) 202311184495.3

(51) Int. Cl. B29C 64/218; B29C 64/153; B29C 64/214; B29C 64/321; B33Y 10/00; B33Y 30/00

(52) U.S. Cl. CPC B29C 64/218; B29C 64/153; B29C 64/214; B29C 64/321; B33Y 10/00; B33Y 30/00

(57) ABSTRACT

An integrated device of bi-directional ultrasonic rolling, powder spreading, and compaction for additive manufacturing is provided, including an integrated device of ultrasonic rolling and powder spreading, and a platform lifting device. The integrated device of ultrasonic rolling and powder spreading is located above the platform lifting device. It can achieve ultrasonic rolling composite additive manufacturing, synchronously carry out ultrasonic rolling strengthening during selective laser melting process, improve the performance of manufacturing components, and the integrated device of ultrasonic rolling and powder spreading can achieve bi-directional strengthening, powder spreading and compaction. The feeding device is used to spread the powder from above, and the reflux gas in the gas reflux channel can reduce the falling speed of particles with higher density in the composite material powder, enabling them to fall synchronously with small particles, reducing the phenomenon of composite material powder delamination caused by differences in particle density.

### CROSS-REFERENCE TO RELATED APPLICATIONS

This application claims to the benefit of priority from Chinese Application No. 202311184495.3 with a filing date of Sep. 14, 2023. The content of the aforementioned applications, including any intervening amendments thereto, are incorporated herein by reference.

### TECHNICAL FIELD

The present disclosure relates to an additive manufacturing platform, in particular to a method and a device for ultrasonic rolling assisted laser additive manufacturing, relating to the technical field of additive manufacturing.

### BACKGROUND

Additive manufacturing (AM), also known as 3D printing, is an emerging advanced manufacturing technology that, in contrast to traditional subtractive manufacturing, creates objects by stacking materials layer by layer instead of cutting or carving them.

Selective laser melting (SLM) is an advanced additive manufacturing (3D printing) technology in which metal powder is uniformly sprayed onto a layer on the workbench during the SLM process, and then irradiated onto the powder layer using a high-power laser beam along a predetermined path. The high energy of the laser beam causes the local area of the powder to quickly melt and form a solid bond. Subsequently, the workbench descends one layer, a new layer of powder is sprayed, and the laser scanning process is repeated, layer by layer stacking, ultimately constructing a complete 3D part.

In existing technology, such as the disclosure of CN115229203A, a nickel titanium based alloy and titanium alloy composite material and its 4D printing method are based on selective laser melting to print the nickel titanium based alloy into shape. As the lower layer material, a mixed material is laid on the surface of the lower layer material, and selective laser melting is used to print the mixed material into shape to obtain a composite material with an upper layer of titanium alloy and a lower layer of nickel titanium based alloy, ensuring the overall performance of the composite material. However, the surface of additive manufactured parts often has relatively large roughness. This is because during the additive manufacturing process, materials accumulate through nozzles or laser melting, resulting in an uneven surface. In addition, the bonding between material layers can also lead to an increase in surface roughness.

### SUMMARY

The objective of the present disclosure is to provide an integrated device of bi-directional ultrasonic rolling, powder spreading, and compaction for additive manufacturing, in order to solve at least one of the technical problems mentioned above.

The present disclosure achieves the above objectives through the following technical solutions: An integrated device of bi-directional ultrasonic rolling, powder spreading, and compaction for additive manufacturing, including an integrated device of ultrasonic rolling and powder spreading and a platform lifting device, the integrated device of ultrasonic rolling and powder spreading is arranged above the platform lifting device, and both the integrated device of ultrasonic rolling and powder spreading and the platform lifting device are arranged inside the working box.

The integrated device of ultrasonic rolling and powder spreading includes a feeding device, an ultrasonic rolling device, a support, a moving device, and a compaction device. The feeding device is connected to the upper end of the support, the moving device is located on one side of the feeding device, and the ultrasonic rolling device is located at the front end of the compaction device in the direction of movement. The feeding device is connected to the moving device through a first connection hole, the ultrasonic rolling device is connected to a second sliding groove of the support through a second sliding rod, the support is respectively connected to the first powder scraper and the second powder scraper through fixing holes for powder scraper, the first powder scraper and the second powder scraper are symmetrically arranged with respect to a compression roller, and bearings at both ends of the compaction device are connected to bearing grooves provided on the support.

The feeding device includes a negative pressure pump, a feeding box, a powder channel, and an isolation plate. The negative pressure pump is connected to the top of the feeding box, the powder channel is located inside the feeding box, and the isolation plate is located inside the feeding box.

Two sets of the supports are provided. Each of the supports is provided with a motor bracket, a first sliding groove, and the second sliding groove, the motor bracket is fixedly connected to an upper side of one of the supports, the first sliding groove is provided at the top of the support, and the second sliding groove is provided at the bottom of the support.

The platform lifting device includes a storage box platform, a printing platform, and a powder collection device. The storage box platform is provided directly above the printing platform, and the powder collection device is located on both sides of the printing platform. The powder collection device includes a powder collection port and a powder collection box, the powder collection port is located at the top of the powder collection box, and the powder collection box is fixedly connected to two sides of the bottom of the working box.

As a further solution of the present disclosure, the platform lifting device further includes a first lead screw nut, a first lead screw, a first coupling, and a servo motor. The bottom of the printing platform is supported by the first lead screw, and the bottom of the printing platform is fixedly connected to a first lead screw nut. The upper end of the first lead screw is threaded inside the first lead screw nut, and the lower end of the first lead screw is connected to a rotation shaft of the servo motor through the first coupling.

As a further solution of the present disclosure, the feeding device further includes a separation gate, a feeding port, a material storage box, a feeding pipeline, a gas reflux channel, and an air inlet channel. The separation gate is horizontally inserted into the feeding box, the feeding port is provided on the upper side of the feeding box, the material storage box is installed on the storage box platform, the material storage box is connected to the feeding port through the feeding pipeline, the gas reflux channel is located inside the bottom of the feeding box, the gas reflux channel is upward at a 45° angle, and the air inlet channel is provided at the top of the feeding box.

As a further solution of the present disclosure, the ultrasonic rolling device includes a transducer, a horn, the second sliding rod, a vibration roller, and a vibration roller fixing bracket. The transducer is connected to the horn, the horn is in contact with the vibration roller, the vibration roller is located inside the vibration roller fixing bracket, and two ends of the vibration roller are connected to the second sliding rod.

As a further solution of the present disclosure, the support further includes a connecting rod protection shell, the connecting rod protection shell is arranged in a semi-circular ring shape, and the connecting rod protection shell is fixedly connected to the periphery of the second sliding groove.

As a further solution of the present disclosure, the moving device includes a moving connecting plate, a horizontal moving unit, and a vertical moving unit for driving the movement of the feeding device. The moving connecting plate is slidably connected to the polished shaft horizontally set on upper ends of the two sets of the supports, the vertical moving unit is set on the moving connecting plate, and the moving connecting plate is connected to one of the supports through the horizontal moving unit. The horizontal moving unit includes a second stepper motor, a third coupling, a third lead screw nut, and a third lead screw. The second stepper motor is fixedly installed on the motor bracket, a rotation shaft of the second stepper motor is connected to the third lead screw through the third coupling, the body of the third lead screw is threaded with the third lead screw nut, and the third lead screw nut is fixedly connected to one side of the moving connecting plate. The vertical moving unit includes a first stepper motor, a second coupling, a second lead screw, and a second lead screw nut. The first stepper motor is fixedly connected to the middle of the upper end of the moving connecting plate, a rotation shaft of the first stepper motor is connected to the second lead screw through the second coupling, the body of the second lead screw is threaded with the second lead screw nut, and the second lead screw nut is fixedly connected to the first connection hole connected with a side wall of the feeding box.

As a further solution of the present disclosure, the moving device further includes a third stepper motor, a synchronous wheel, a synchronous belt, and a sliding rail. The sliding rail is fixedly connected to both sides of the platform lifting device, the support is provided above the sliding rail, the outer side of the support is fixedly connected to a sliding block through a fixing hole for sliding block, the sliding block is movably clamped on the sliding rail, one end of the sliding rail is fixedly connected to the third stepper motor, the synchronous wheel is fixedly connected to a rotation shaft of the third stepper motor, the other end of the sliding rail is rotationally connected to another synchronous wheel, the two synchronous wheels are connected to the synchronous belt, and a belt body of the synchronous belt is connected to the sliding block, and an outer surface of the support is fixedly connected to a steering engine connected to two ends of the connecting rod.

As a further solution of the present disclosure, the compaction device includes a compression spring, a compression block, the bearings, the compression roller, the first powder scraper, and the second powder scraper. One end of the compression spring is connected to the bearing groove for placing the bearing, and the other end of the compression spring is connected to the compression block. The compression block is in contact with the bearing, and the bearings are sleeved at both ends of the compression roller.

A method for manufacturing the integrated device of bi-directional ultrasonic rolling, powder spreading, and compaction for additive manufacturing described above includes the following steps:
Step 1, lifting the platform lifting device to a highest position, moving the integrated device of ultrasonic rolling and powder spreading onto the platform lifting device, and moving the ultrasonic rolling device and the feeding box of the feeding device to an extreme position near the printing platform;
Step 2, descending the platform lifting device by one layer, moving the integrated device of ultrasonic rolling and powder spreading towards the printing platform, then spreading powder by the feeding box, and flattening the powder by the first powder scraper, and then compacting the powder by the compression roller; finally, scraping excess powder, by the first powder scraper, into the powder collection device of the platform lifting device to complete a first layer of powder laying, and laser sintering the first layer of the powder;
Step 3, driving the moving connecting plate to rise under a rotation of the second lead screw, then the moving connecting plate drives the feeding device to rise, driving the ultrasonic rolling device to move along the second sliding groove to another extreme position under the rotation of the connecting rod, moving the feeding box to another extreme position under a drive of the moving device, the integrated device of ultrasonic rolling and powder spreading moves towards the printing platform, driving the moving connecting plate to descend under the rotation of the second lead screw, then driving the feeding device to descend by the moving connecting plate, then the ultrasonic rolling device starts, rolling a first layer of printed components flat, and spreading the powder once again by the feeding box, scraping the powder by the second powder scraper, then compacting the dispersed powder once again by the compression roller, then scraping the excess powder into the powder collection device of the platform lifting device by the second powder scraper to complete a second layer of powder laying, and then laser sintering the second layer of the powder;
Step 4, repeating the above process until printing is completed.

The advantageous effects of the present disclosure are as following:
1. The present disclosure integrates powder spreading, compaction, and ultrasonic rolling. A compression roller is used to compact the powder spread by the powder scraper, reducing material gaps and improving material properties. During the powder spreading process of each layer, ultrasonic rolling is synchronously used to strengthen each material, making the material more dense and the surface smoother, which can be used for improving the performance of additive manufacturing materials.
2. The present disclosure can achieve bidirectional powder spreading, compaction, and ultrasonic rolling reinforcement. After completing one layer of powder spreading, compaction, and ultrasonic rolling reinforcement, the integrated powder spreading unit can change the position of the feeding device and the ultrasonic rolling device through connecting rods and sliding rods. The powder scrapers are symmetrically arranged on both sides, which can achieve bidirectional powder spreading, compaction, and ultrasonic rolling reinforcement.
3. The feeding box of the present disclosure is equipped with a gas reflux channel. The reflux gas upward at 45° can reduce the falling speed of particles with higher density in the composite material powder, enabling them to fall synchronously with small particles, reducing the phenomenon of composite material powder delamination caused by differences in particle density.

### BRIEF DESCRIPTION OF THE DRAWINGS

FIG. 1 is a schematic diagram of the overall structure of the present disclosure;

FIG. 2 is a schematic diagram of the structure of the integrated device of ultrasonic rolling and powder spreading of the present disclosure;

FIG. 3 is a schematic diagram of the structure of the platform lifting device of the present disclosure;

FIG. 4 is a schematic diagram of the structure of the feeding device of the present disclosure;

FIG. 5 is a schematic diagram of the cross-sectional structure of the feeding device of the present disclosure;

FIG. 6 is a schematic diagram of the axonometric structure of the feeding device of the present disclosure;

FIG. 7 is a schematic diagram of structure of the feeding box of the present disclosure from the top and the bottom;

FIG. 8 is a section view of the structure of the ultrasonic rolling device of the present disclosure from the front;

FIG. 9 is a section view of the structure of the ultrasonic rolling device of the present disclosure from the lateral side;

FIG. 10 is a partial sectional view of the structure of the support of the present disclosure;

FIG. 11 is a partial sectional view of the structure of the moving device of the present disclosure;

FIG. 12 is a schematic diagram of the structure of the mobile device of the present disclosure from the top;

FIG. 13 is a section view of the structure of the support of the present disclosure from the lateral side;

FIG. 14 is a partial sectional view of the structure of the compaction device of the present disclosure

FIG. 15 is a schematic diagram of the structure of the powder collection device of the present disclosure;

FIG. 16 is a schematic diagram of the structure of the material layering manufactured by the present disclosure;

FIG. 17 is a work flow chart of the present disclosure.

The reference marks in the figures: 1. integrated device of ultrasonic rolling and powder spreading, 2. platform lifting device, 201. storage box platform, 202. printing platform, 203. powder collection device, 2031. powder collection port, 2032. powder collection box, 204. first lead screw nut, 205. first lead screw, 206. first coupling, 207. servo motor, 3. feeding device, 301. negative pressure pump, 302. feeding box, 303. first connection hole, 304. separation gate, 305. powder channel, 306. isolation plate, 307. gas reflux channel, 308. feeding port, 309. material storage box, 310. feeding pipeline, 311. air inlet channel, 4. ultrasonic rolling device, 401. transducer, 402. horn, 403. second sliding rod, 404. vibration roller, 405. vibration roller fixing bracket, 5. support, 501. motor bracket, 502. first sliding groove, 503. connecting rod protection shell, 504. second sliding groove, 505. connecting rod, 506. fixing hole for powder scraper, 507. fixing hole for sliding block, 6. moving device, 601. first stepper motor, 602. second coupling, 603. second lead screw, 604. second lead screw nut, 605. second stepper motor, 606. third coupling, 607. third lead screw nut, 608. third lead screw, 609. polished shaft, 610. third stepper motor, 611. synchronous wheel, 612. synchronous belt, 613. sliding rail, 614. sliding block, 615. moving connecting plate, 616. steering engine, 7. compaction device, 701. compression spring, 702. compression block, 703. bearing, 704. compression roller, 705. first powder scraper, 706. second powder scraper, 801. surface powder layer, 802. bottom powder layer, 803. powder compaction layer, 804. powder leveling layer, 805. powder accumulation layer, 806. reinforced molding layer, 807. molding layer to be reinforced, 9. working box.

### DETAILED DESCRIPTION OF THE EMBODIMENTS

The technical solutions in the embodiments of the present disclosure will be clearly and completely described below in conjunction with the accompanying drawings in the embodiments of the present disclosure, and it is apparent that the described embodiments are only a part of the embodiments of the present disclosure and not all of the embodiments. Based on the embodiments in the present disclosure, all other embodiments obtained by a person of ordinary skill in the art without making creative labour fall within the scope of the present disclosure.

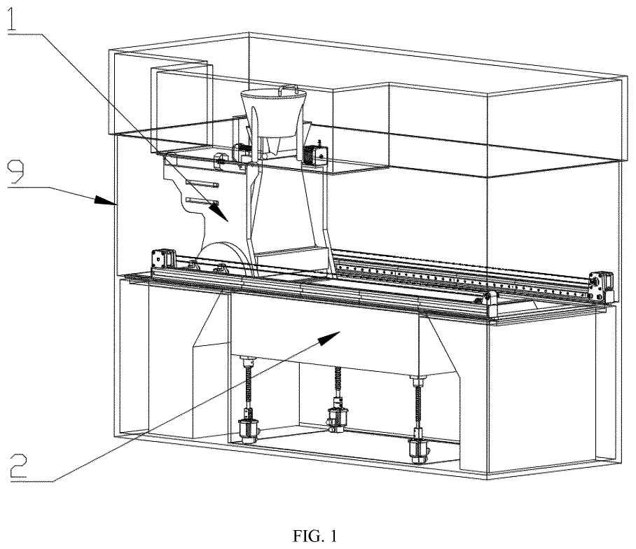

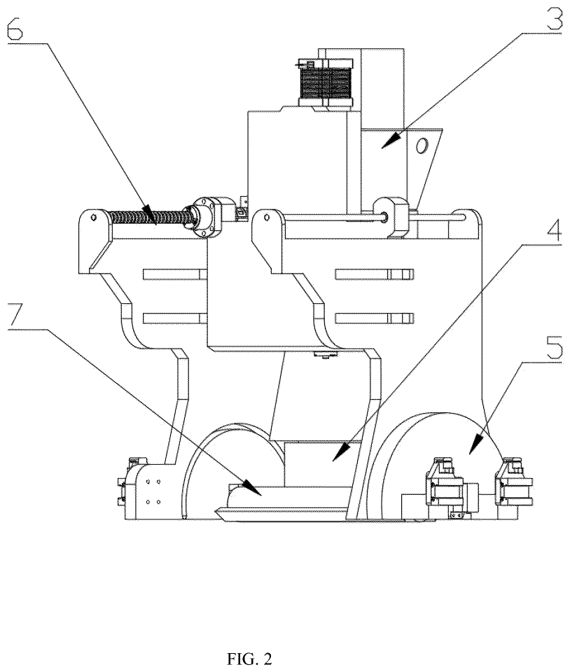

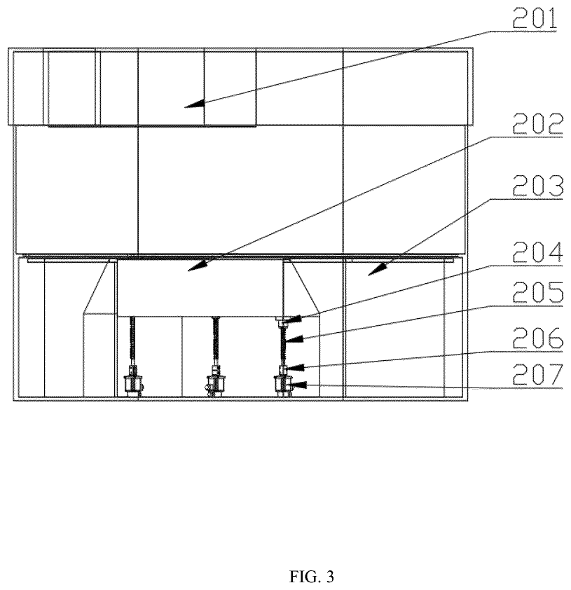

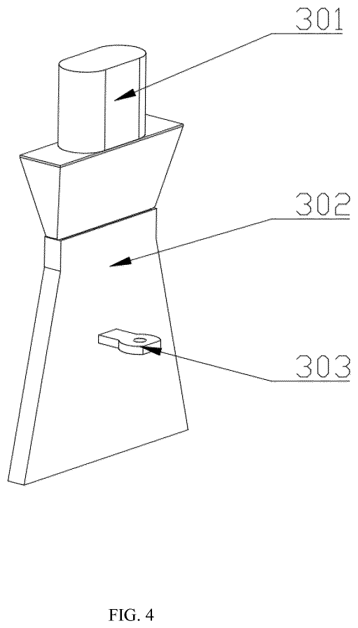

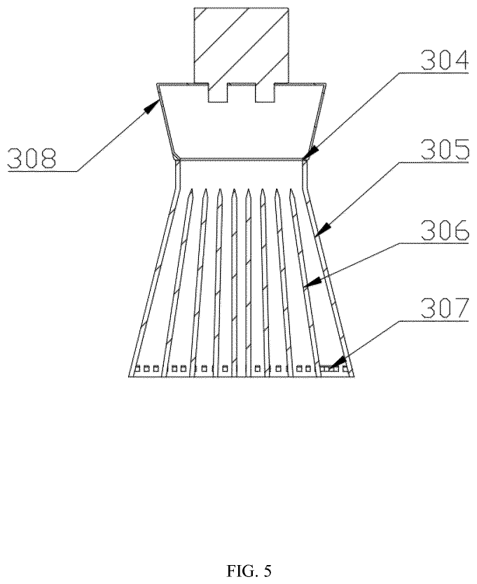

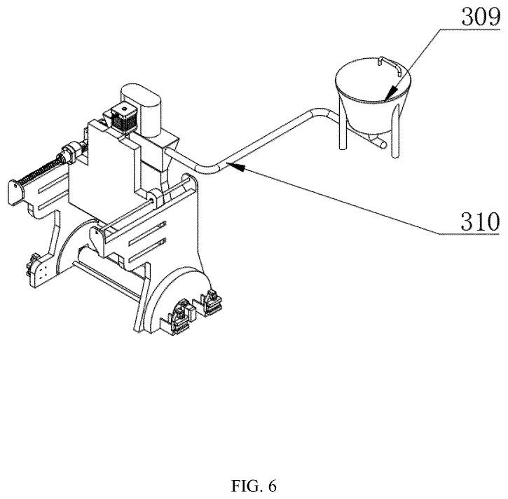

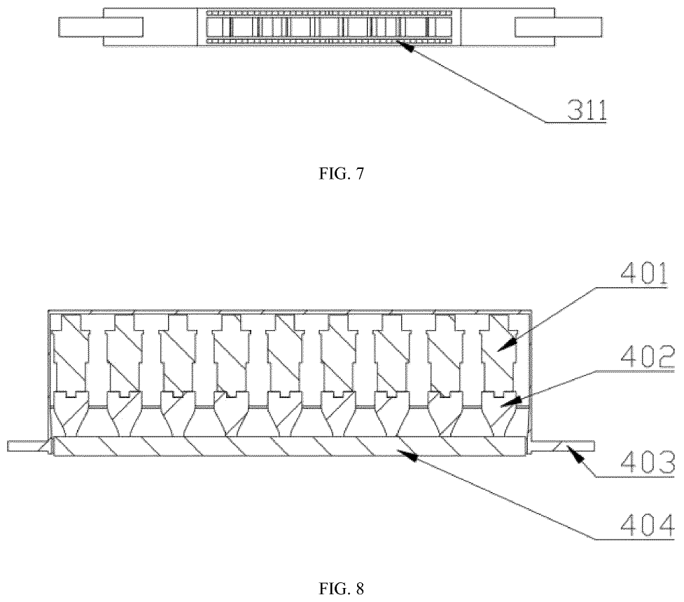

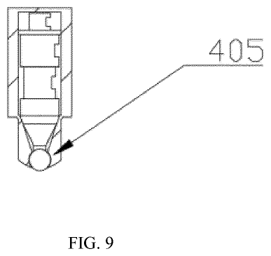

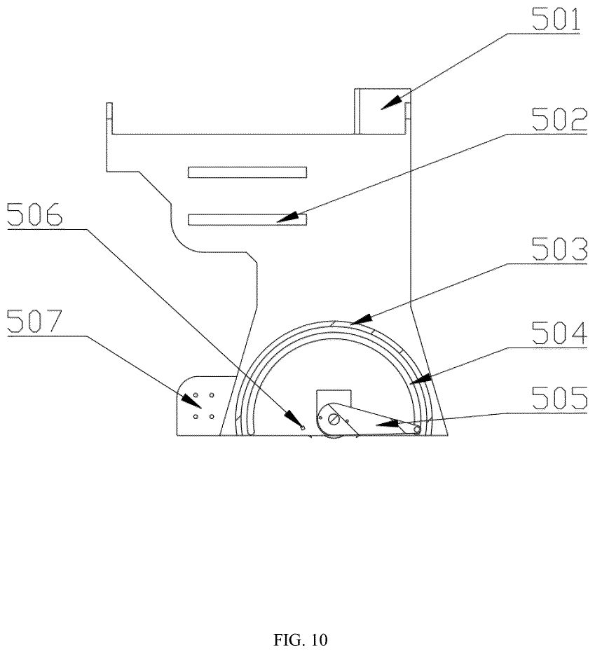

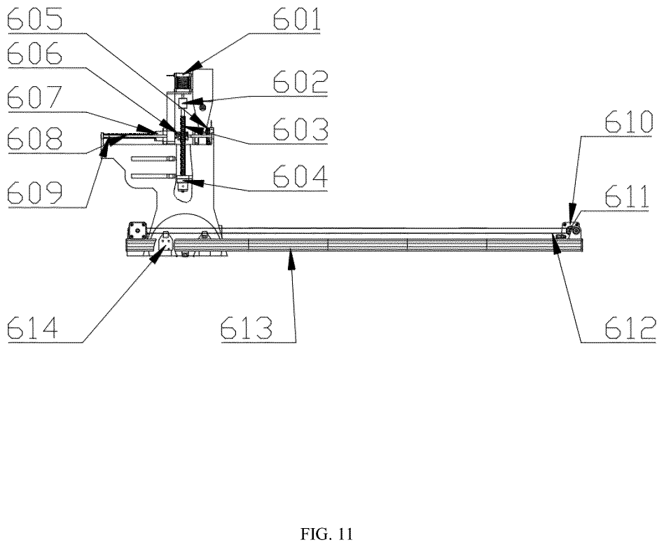

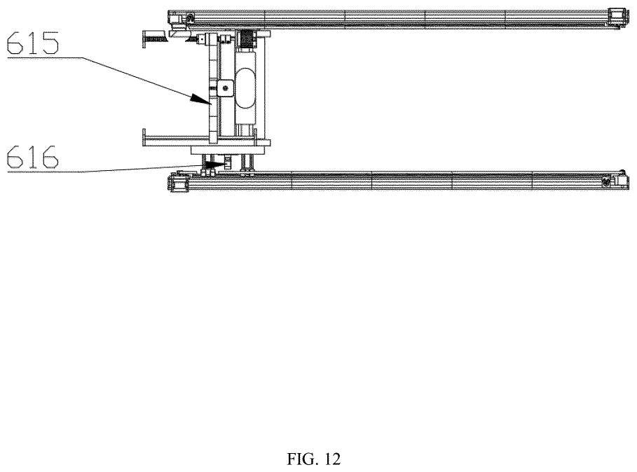

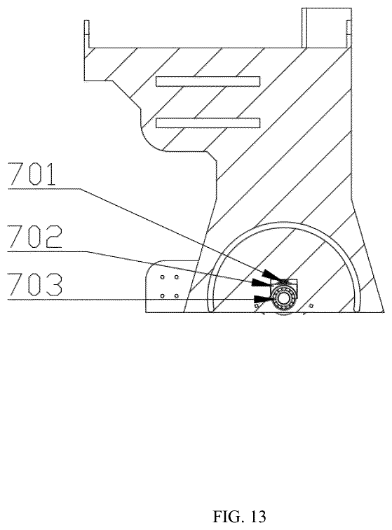

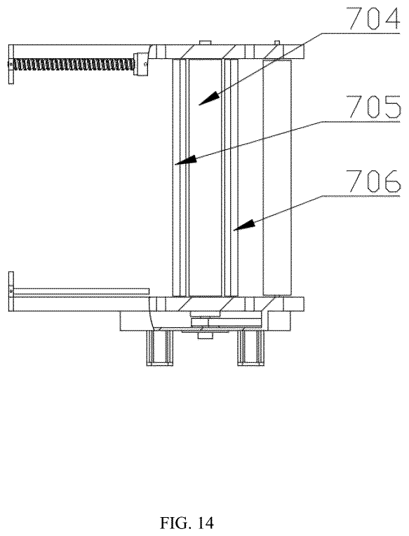

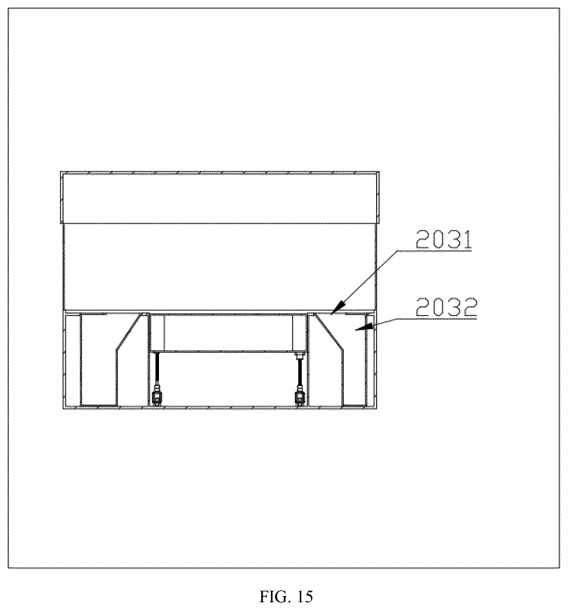

Embodiment 1, as shown in FIG. 1 to FIG. 15, an integrated device of bi-directional ultrasonic rolling, powder spreading, and compaction for additive manufacturing is provided, which includes an integrated device of ultrasonic rolling and powder spreading 1 and a platform lifting device 2. The integrated device of ultrasonic rolling and powder spreading 1 is arranged above the platform lifting device 2, and both the integrated device of ultrasonic rolling and powder spreading 1 and the platform lifting device 2 are arranged inside the working box 9.

The integrated device of ultrasonic rolling and powder spreading 1 includes a feeding device 3, an ultrasonic rolling device 4, a support 5, a moving device 6, and a compaction device 7. The feeding device 3 is connected to the upper end of the support 5, the moving device 6 is located on one side of the feeding device 3, and the ultrasonic rolling device 4 is located at the front end of the compaction device 7 in the direction of movement. The feeding device 3 is connected to the moving device 6 through a first connection hole 303, the ultrasonic rolling device 4 is connected to a second sliding groove 504 of the support 5 through a second sliding rod 403, the support 5 is respectively connected to the first powder scraper 705 and the second powder scraper 706 through fixing holes for powder scraper 506, the first powder scraper 705 and the second powder scraper 706 are symmetrically arranged with respect to a compression roller 704, and bearings 703 at both ends of the compaction device 7 are connected to bearing grooves provided on the support 5.

The feeding device 3 includes a negative pressure pump 301, a feeding box 302, a powder channel 305, and an isolation plate 306, the negative pressure pump 301 is connected to a top of the feeding box 302, the powder channel 305 is located inside the feeding box 302, and the isolation plate 306 is located inside the feeding box 302.

Two sets of the supports 5 are provided. Each of the supports 5 is provided with a motor bracket 501, a first sliding groove 502, and the second sliding groove 504. The motor bracket 501 is fixedly connected to the upper side of one of the supports 5, the first sliding groove 502 is provided at the top of the support 5, and the second sliding groove 504 is provided at the bottom of the support 5.

The platform lifting device 2 includes a storage box platform 201, a printing platform 202, and a powder collection device 203. The storage box platform 201 is provided directly above the printing platform 202, and the powder collection device 203 is located on both sides of the printing platform 202. The powder collection device 203 includes a powder collection port 2031 and a powder collection box 2032, the powder collection port 2031 is located at the top of the powder collection box 2032, and the powder collection box 2032 is fixedly connected to two sides of the bottom of the working box 9.

Embodiment 2, in addition to all the technical features in Embodiment 1, this embodiment further includes: the platform lifting device 2 further includes a first lead screw nut 204, a first lead screw 205, a first coupling 206, and a servo motor 207. The bottom of the printing platform 202 is supported by the first lead screw 205, and the bottom of the printing platform 202 is fixedly connected to a first lead screw nut 204. The upper end of the first lead screw 205 is threaded inside the first lead screw nut 204, and the lower end of the first lead screw 205 is connected to a rotation shaft of the servo motor 207 through the first coupling 206.

Embodiment 3, in addition to all the technical features in Embodiment 1, this embodiment further includes: the feeding device 3 further includes a separation gate 304, a feeding port 308, a material storage box 309, a feeding pipeline 310, a gas reflux channel 307, and an air inlet channel 311. The separation gate 304 is horizontally inserted into the feeding box 302, and the feeding port 308 is provided on an upper side of the feeding box 302. The material storage box 309 is installed on the storage box platform 201, and the material storage box 309 is connected to the feeding port 308 through the feeding pipeline 310. The gas reflux channel 307 is located inside the bottom of the feeding box 302, the gas reflux channel 307 is upward at a 45° angle, and the air inlet channel 311 is provided at the top of the feeding box 302.

The ultrasonic rolling device 4 includes a transducer 401, a horn 402, the second sliding rod 403, a vibration roller 404, and a vibration roller fixing bracket 405. The transducer 401 is connected to the horn 402, the horn 402 is in contact with the vibration roller 404, the vibration roller 404 is located inside the vibration roller fixing bracket 405, and two ends of the vibration roller 404 are connected to the second sliding rod 403.

The support 5 further includes a connecting rod protection shell 503, the connecting rod protection shell is arranged in a semi-circular ring shape, and the connecting rod protection shell 503 is fixedly connected to a periphery of the second sliding groove 504.

Embodiment 4, in addition to all the technical features in Embodiment 1, this embodiment further includes: the moving device 6 includes a moving connecting plate 615, a horizontal moving unit, and a vertical moving unit for driving a movement of the feeding device 3, the moving connecting plate 615 is slidably connected to a polished shaft 609 horizontally set on upper ends of the two sets of the supports 5, the vertical moving unit is set on the moving connecting plate 615, and the moving connecting plate 615 is connected to one of the supports 5 through the horizontal moving unit. The horizontal moving unit includes a second stepper motor 605, a third coupling 606, a third lead screw nut 607, and a third lead screw 608. The second stepper motor 605 is fixedly installed on the motor bracket 501, a rotation shaft of the second stepper motor 605 is connected to the third lead screw 608 through the third coupling 606, a body of the third lead screw is threaded with the third lead screw nut 607, and the third lead screw nut 607 is fixedly connected to one side of the moving connecting plate 615. The vertical moving unit includes a first stepper motor 601, a second coupling 602, a second lead screw 603, and a second lead screw nut 604. The first stepper motor 601 is fixedly connected to the middle of the upper end of the moving connecting plate 615, a rotation shaft of the first stepper motor 601 is connected to the second lead screw 603 through the second coupling 602, the body of the second lead screw 603 is threaded with the second lead screw nut 604, and the second lead screw nut 604 is fixedly connected to the first connection hole 303 connected with a side wall of the feeding box 302.

The moving device 6 further includes a third stepper motor 610, a synchronous wheel 611, a synchronous belt 612, and a sliding rail 613. The sliding rail 613 is fixedly connected to both sides of the platform lifting device 2, the support 5 is provided above the sliding rail 613, the outer side of the support 5 is fixedly connected to a sliding block 614 through a fixing hole for sliding block 507, and the sliding block 614 is movably clamped on the sliding rail 613. One end of the sliding rail 613 is fixedly connected to the third stepper motor 610, the synchronous wheel 611 is fixedly connected to a rotation shaft of the third stepper motor 610, the other end of the sliding rail 613 is rotationally connected to another synchronous wheel 611, the two synchronous wheels 611 are connected to the synchronous belt 612, and the belt body of the synchronous belt 612 is connected to the sliding block 614, and an outer surface of the support 5 is fixedly connected to a steering engine 616 connected to two ends of the connecting rod 505.

The compaction device 7 includes a compression spring 701, a compression block 702, the bearing 703, the compression roller 704, the first powder scraper 705, and the second powder scraper 706. One end of the compression spring 701 is connected to the bearing groove for placing the bearing 703, and the other end of the compression spring 701 is connected to the compression block 702, the compression block 702 is in contact with the bearing 703, and the bearings 703 are sleeved at both ends of the compression roller 704.

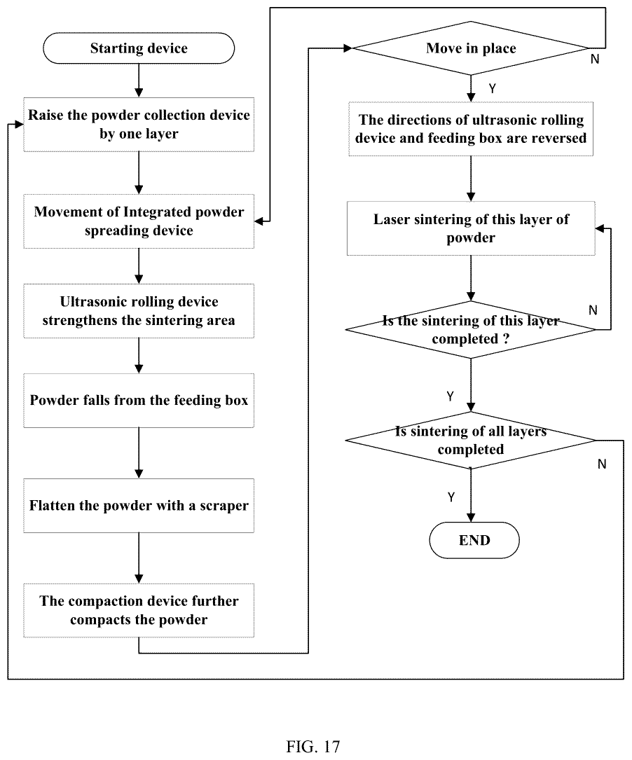

Embodiment 5, as shown in FIG. 17, a method for manufacturing the integrated device of bi-directional ultrasonic rolling, powder spreading, and compaction for additive manufacturing described above is provided, including the following steps:
Step 1, lifting the platform lifting device 2 to a highest position, moving the integrated device of ultrasonic rolling and powder spreading 1 onto the platform lifting device 2, and moving the ultrasonic rolling device 4 and the feeding box 302 of the feeding device 3 to an extreme position near the printing platform 202;
Step 2, descending the platform lifting device 2 by one layer, moving the integrated device of ultrasonic rolling and powder spreading I towards the printing platform 202, then spreading powder by the feeding box 302, and flattening the powder by the first powder scraper 705, and then compacting the powder by the compression roller 704; finally, scraping excess powder, by the first powder scraper 705, into the powder collection device 203 of the platform lifting device 2 to complete a first layer of powder laying, and laser sintering the first layer of the powder;
Step 3, driving the moving connecting plate 615 to rise under a rotation of the second lead screw 603, then the moving connecting plate 615 drives the feeding device 3 to rise, driving the ultrasonic rolling device 4 to move along the second sliding groove 504 to another extreme position under the rotation of the connecting rod 505, moving the feeding box 302 to another extreme position under a drive of the moving device 6, the integrated device of ultrasonic rolling and powder spreading 1 moves towards the printing platform 202, driving the moving connecting plate 615 to descend under the rotation of the second lead screw 603, then driving the feeding device 3 to descend by the moving connecting plate 615, then the ultrasonic rolling device 4 starts, rolling a first layer of printed components flat, and spreading the powder once again by the feeding box 302, scraping the powder by the second powder scraper 706, then compacting the dispersed powder once again by the compression roller 704, then scraping the excess powder into the powder collection device 203 of the platform lifting device 2 by the second powder scraper 706 to complete a second layer of powder laying, and then laser sintering the second layer of the powder;
Step 4, repeating the above process until printing is completed.

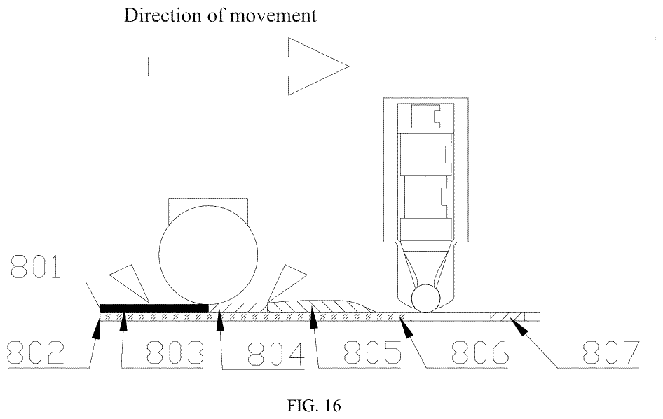

Embodiment 6, as shown in FIG. 16, an integrated device of bi-directional ultrasonic rolling, powder spreading, and compaction for additive manufacturing is provided. The manufactured material includes a surface powder layer 801 and a bottom powder layer 802. Before being compacted by the compaction device 7, there is a powder compaction layer 803 between the surface and bottom layers. After compaction, a powder leveling layer 804 is formed above the surface layer, and then the powder accumulation layer 805 is scraped off by a scraper to form a molding layer to be reinforced 807. After passing through the ultrasonic rolling device 7, a reinforced molding layer 806 is formed.

Working principle: To achieve the integration of additive manufacturing and ultrasonic rolling, ultrasonic rolling strengthening is carried out synchronously during the additive manufacturing process to improve the performance of manufactured components. The integrated device of ultrasonic rolling and powder spreading 1 can achieve bi-directional strengthening, powder laying, and compaction. The powder is released from above by the feeding box 302, and the composite material powder is uniformly dropped using reflux gas to reduce material delamination.

For those skilled in the art, it is evident that the present disclosure is not limited to the details of the exemplary embodiments mentioned above, and can be implemented in other specific forms without departing from the spirit or basic features of the present disclosure. Therefore, from any perspective, the embodiments should be regarded as exemplary and non restrictive, and the scope of the present disclosure is limited by the accompanying claims rather than the above description. Therefore, it is intended to encompass all variations that fall within the meaning and scope of equivalent elements of the claims within the present disclosure. Any accompanying drawings in the claims should not be regarded as limiting the claims involved.

In addition, it should be understood that although this specification is described according to the embodiments, not each embodiment only includes an independent technical solution. This description in the specification is for clarity only. Those skilled in the art should treat the specification as a whole, and the technical solutions in each embodiment can be appropriately combined to form other embodiment that those skilled in the art can understand.

1. An integrated device of bi-directional ultrasonic rolling, powder spreading, and compaction for additive manufacturing, comprising an integrated device of ultrasonic rolling and powder spreading (1) and a platform lifting device (2), wherein the integrated device of ultrasonic rolling and powder spreading (1) is arranged above the platform lifting device (2), and both the integrated device of ultrasonic rolling and powder spreading (1) and the platform lifting device (2) are arranged inside the working box (9);
the integrated device of ultrasonic rolling and powder spreading (1) comprises a feeding device (3), an ultrasonic rolling device (4), a support (5), a moving device (6), and a compaction device (7), wherein the feeding device (3) is connected to an upper end of the support (5), the moving device (6) is located on one side of the feeding device (3), and the ultrasonic rolling device (4) is located at a front end of the compaction device (7) in a direction of movement; the feeding device (3) is connected to the moving device (6) through a first connection hole (303), the ultrasonic rolling device (4) is connected to a second sliding groove (504) of the support (5) through a second sliding rod (403), the support (5) is respectively connected to the first powder scraper (705) and the second powder scraper (706) through fixing holes for powder scraper (506),
the first powder scraper (705) and the second powder scraper (706) are symmetrically arranged with respect to a compression roller (704), and bearings (703) at both ends of the compaction device (7) are connected to bearing grooves provided on the support (5);
the feeding device (3) comprises a negative pressure pump (301), a feeding box (302), a powder channel (305), and an isolation plate (306), wherein the negative pressure pump (301) is connected to a top of the feeding box (302), the powder channel (305) is located inside the feeding box (302), and the isolation plate (306) is located inside the feeding box (302);
two sets of the supports (5) are provided, each of the supports (5) is provided with a first sliding groove (502) and the second sliding groove (504), and a motor bracket (501) is fixedly connected to an upper side of one of the supports (5); the first sliding groove (502) is provided at a top of each support (5), and the second sliding groove (504) is provided at a bottom of each support (5);
the platform lifting device (2) comprises a storage box platform (201), a printing platform (202), and a powder collection device (203), the storage box platform (201) is provided directly above the printing platform (202), and the powder collection device (203) is located on both sides of the printing platform (202); the powder collection device (203) comprises a powder collection port (2031) and a powder collection box (2032), the powder collection port (2031) is located at a top of the powder collection box (2032), and the powder collection box (2032) is fixedly connected to two sides of a bottom of the working box (9);
the platform lifting device (2) further comprises a first lead screw nut (204), a first lead screw (205), a first coupling (206), and a servo motor (207), a bottom of the printing platform (202) is supported by the first lead screw (205), the bottom of the printing platform (202) is fixedly connected to a first lead screw nut (204), an upper end of the first lead screw (205) is threaded inside the first lead screw nut (204), and a lower end of the first lead screw (205) is connected to a rotation shaft of the servo motor (207) through the first coupling (206);
the feeding device (3) further comprises a separation gate (304), a feeding port (308), a material storage box (309), a feeding pipeline (310), a gas reflux channel (307), and an air inlet channel (311), the separation gate (304) is horizontally inserted into the feeding box (302), the feeding port (308) is provided on an upper side of the feeding box (302), the material storage box (309) is installed on the storage box platform (201), the material storage box (309) is connected to the feeding port (308) through the feeding pipeline (310), the gas reflux channel (307) is located inside a bottom of the feeding box (302), the gas reflux channel (307) is upward at a 45° angle, and the air inlet channel (311) is provided at a top of the feeding box (302);
the ultrasonic rolling device (4) comprises a transducer (401), a horn (402), the second sliding rod (403), a vibration roller (404), and a vibration roller fixing bracket (405), the transducer (401) is connected to the horn (402), the horn (402) is in contact with the vibration roller (404), the vibration roller (404) is located inside the vibration roller fixing bracket (405), and two ends of the vibration roller (404) are connected to the second sliding rod (403);
the moving device (6) comprises a moving connecting plate (615), a horizontal moving unit, and a vertical moving unit for driving a movement of the feeding device (3), the moving connecting plate (615) is slidably connected to a polished shaft (609) horizontally set on upper ends of the two sets of the supports (5), the vertical moving unit is set on the moving connecting plate (615), and the moving connecting plate (615) is connected to one of the supports (5) through the horizontal moving unit; the horizontal moving unit comprises a second stepper motor (605), a third coupling (606), a third lead screw nut (607), and a third lead screw (608), the second stepper motor (605) is fixedly installed on the motor bracket (501), a rotation shaft of the second stepper motor (605) is connected to the third lead screw (608) through the third coupling (606), a body of the third lead screw is threaded with the third lead screw nut (607), and the third lead screw nut (607) is fixedly connected to one side of the moving connecting plate (615); the vertical moving unit comprises a first stepper motor (601), a second coupling (602), a second lead screw (603), and a second lead screw nut (604), the first stepper motor (601) is fixedly connected to a middle of an upper end of the moving connecting plate (615), a rotation shaft of the first stepper motor (601) is connected to the second lead screw (603) through the second coupling (602), a body of the second lead screw (603) is threaded with the second lead screw nut (604), and the second lead screw nut (604) is fixedly connected to the first connection hole (303) connected with a side wall of the feeding box (302);
the moving device (6) further comprises a third stepper motor (610), a synchronous wheel (611), a synchronous belt (612), and a sliding rail (613), the sliding rail (613) is fixedly connected to both sides of the platform lifting device (2), the support (5) is provided above the sliding rail (613), an outer side of the support (5) is fixedly connected to a sliding block (614) through a fixing hole for sliding block (507), the sliding block (614) is movably clamped on the sliding rail (613), one end of the sliding rail (613) is fixedly connected to the third stepper motor (610), the synchronous wheel (611) is fixedly connected to a rotation shaft of the third stepper motor (610), the other end of the sliding rail (613) is rotationally connected to another synchronous wheel (611), the two synchronous wheels (611) are connected to the synchronous belt (612), and a belt body of the synchronous belt (612) is connected to the sliding block (614), and an outer surface of the support (5) is fixedly connected to a steering engine (616) connected to two ends of the connecting rod (505);
the compaction device (7) comprises a compression spring (701), a compression block (702), the bearing (703), the compression roller (704), the first powder scraper (705), and the second powder scraper (706), one end of the compression spring (701) is connected to the bearing groove for placing the bearing (703), and the other end of the compression spring (701) is connected to the compression block (702), the compression block (702) is in contact with the bearing (703), and the bearing (703) is sleeved at both ends of the compression roller (704).

2. The integrated device of bi-directional ultrasonic rolling, powder spreading, and compaction for additive manufacturing according to claim 1, characterized in that: the support (5) further comprises a connecting rod protection shell (503), the connecting rod protection shell is arranged in a semi-circular ring shape, and the connecting rod protection shell (503) is fixedly connected to a periphery of the second sliding groove (504).

3. A method for manufacturing the integrated device of bi-directional ultrasonic rolling, powder spreading, and compaction for additive manufacturing according to claim 1, comprising the following steps:
step 1, lifting the platform lifting device (2) to a highest position, moving the integrated device of ultrasonic rolling and powder spreading (1) onto the platform lifting device (2), and moving the ultrasonic rolling device (4) and the feeding box (302) of the feeding device (3) to an extreme position near the printing platform (202);
step 2, descending the platform lifting device (2) by one layer, moving the integrated device of ultrasonic rolling and powder spreading (1) towards the printing platform (202), then spreading powder by the feeding box (302), and flattening the powder by the first powder scraper (705), and then compacting the powder by the compression roller (704); finally, scraping excess powder, by the first powder scraper (705), into the powder collection device (203) of the platform lifting device (2) to complete a first layer of powder laying, and laser sintering the first layer of the powder;
step 3, driving the moving connecting plate (615) to rise under a rotation of the second lead screw (603), then the moving connecting plate (615) drives the feeding device (3) to rise, driving the ultrasonic rolling device (4) to move along the second sliding groove (504) to another extreme position under the rotation of the connecting rod (505), moving the feeding box (302) to another extreme position under a drive of the moving device (6), the integrated device of ultrasonic rolling and powder spreading (1) moves towards the printing platform (202), driving the moving connecting plate (615) to descend under the rotation of the second lead screw (603), then driving the feeding device (3) to descend by the moving connecting plate (615), then the ultrasonic rolling device (4) starts, rolling a first layer of printed components flat, and spreading the powder once again by the feeding box (302), scraping the powder by the second powder scraper (706), then compacting the dispersed powder once again by the compression roller (704), then scraping the excess powder into the powder collection device (203) of the platform lifting device (2) by the second powder scraper (706) to complete a second layer of powder laying, and then laser sintering the second layer of the powder;
step 4, repeating the above process until printing is completed.
